(19) United States
(12) Patent Application Publication
(10) Pub. No.: US 2007/0121337 A1
(43) Pub. Date: May 31, 2007

(54) Headlamp reflector linkage

(76) Inventors: Jeffrey Chapin, Ontario (CA); Brad Park, Ontario (CA); Glenn Gillie, Ontario (CA)

Correspondence Address: Robin W Asher;Clark Hill, 500 Woodward Avenue, Suite 3500, Detroit, MI, 48226-3435, US

(21) Appl. No.: 10/573,725

(22) PCT Filed: Oct. 7, 2004
(86) PCT No.: PCT/CA04/01787

§ 371 Date: Mar. 28, 2006

Related U.S. Application Data
(60) Provisional application No. 60/509,008, filed on Oct. 7, 2003.

(51) Int. Cl. F21V 1/00

(52) U.S. Cl. 362/509

(57) ABSTRACT

A headlamp assembly for a motor vehicle, which includes a housing, and first and second reflectors pivotally secured to the housing. A connecting bar extends between the first and second reflectors for simultaneously adjusting the first reflector in response to the pivotally adjustment of the second reflector.

### FIELD OF THE INVENTION

This invention relates to a headlamp assembly for a motor vehicle. More particularly, the invention relates to a headlamp assembly including a connecting bar for allowing simultaneous pivotal adjustment of high and low beam reflectors.

### DESCRIPTION OF THE RELATED ART

A headlamp assembly for a motor vehicle generally includes high and low beam reflectors disposed within a housing for aiming and shaping light from the headlamp. The headlamp assembly also includes two adjustment systems, one for the high beam reflector and the other for the low beam reflector, for adjusting the position, and thus aim, of the high and low beam reflectors. Each adjustment system typically includes a hinge secured to the housing and an adjustment mechanism for pivoting the reflector about the hinge.

The use of separate adjustment mechanisms presents, however, a problem when adjusting the position of the high and low beam reflectors. Since each reflector must be adjusted independently, it is difficult to accurately position the high and low beam reflectors relative to one another. Also, since many motor vehicles have two headlamp assemblies, a total of four reflectors must be independently adjusted. This independent adjustment can result in variation between the positions of the various reflectors.

The multiple adjustment mechanisms also add to the cost and complexity of the headlamp assembly. Reducing the number of adjustment mechanisms in the headlamp assembly would, therefore, be cost-effective and more efficient from a manufacturing standpoint.

Thus, there remains a need for a headlamp assembly having a single adjustment mechanism for simultaneously adjusting a high and a low beam reflector.

### SUMMARY OF THE INVENTION

According to one aspect of the invention, a headlamp assembly for a motor vehicle includes a housing, and first and second reflectors pivotally secured to the housing. Additionally, the headlamp assembly includes a connecting bar extending between the first and second reflectors for pivotally adjusting the first reflector in response to pivotal adjustment of the second reflector.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a motor vehicle including a headlamp assembly according to the invention;

FIG. 2 is a perspective view of the headlamp assembly; and

FIG. 3 is an exploded, perspective view of the headlamp assembly.

### DETAILED DESCRIPTION OF THE PREFERRED EMBODIMENT

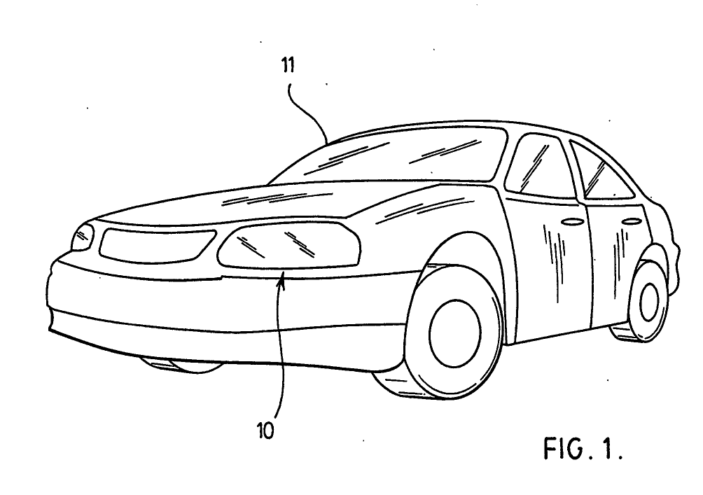

Referring to FIG. 1, a headlamp assembly for a motor vehicle 11 is generally shown at 10. The headlamp assembly 10 provides illumination of a road surface immediately in front of the motor vehicle 11.

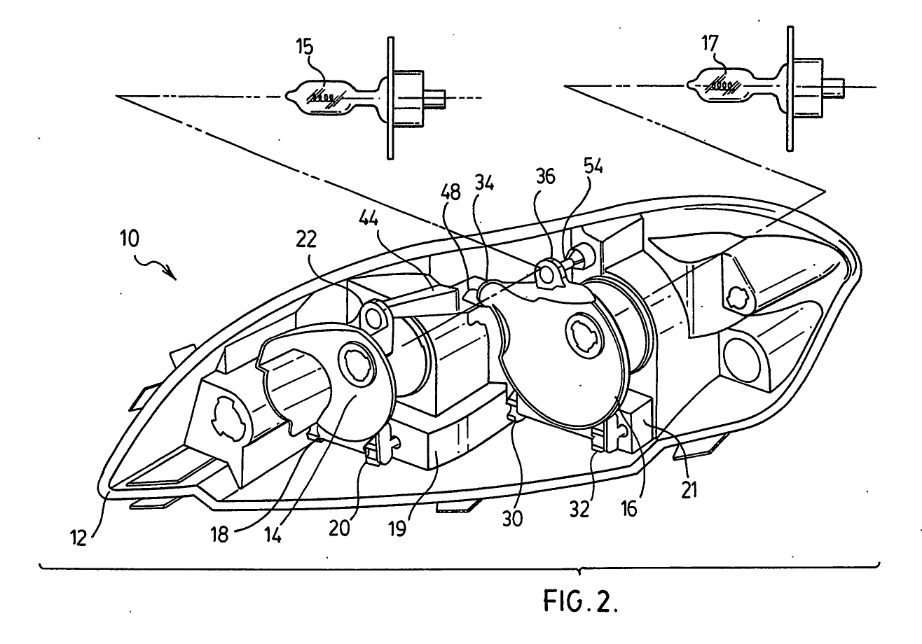

Referring to FIG. 2, the headlamp assembly 10 includes a housing 12. The headlamp assembly 10 also includes first 14 and second 16 reflectors disposed within the housing 12. In a preferred embodiment, the first reflector is a high beam reflector 14 and the second reflector is a low beam reflector 16. Bulbs 15, 17, mounts inside each of the high 14 and low 16 beam reflectors. The high 14 and low 16 beam reflectors focus and aim the light emitted by the electric lamps.

The housing 12 is generally concave and is molded to provide mounting surfaces for the beam reflectors 14, 16. Additionally, the housing 12 is configured to enable light bulbs or other suitable light sources to be mounted thereon. The general contouring of housing 12 is dictated primarily by the vehicle styling. The housing 12 has a plurality of high beam reflector mounting clips 18, 20 fixedly secured thereto and located relative to a high beam mounting embossment 19. In the preferred embodiment, the plurality of high beam reflector mounting clips 18, 20 is integrally formed as part of the housing 12.

The housing 12 further includes a plurality of low beam reflector mounting clips 30, 32 fixedly secured thereto and mounted relative to a low beam light source mounting embossment 21. In the preferred embodiment, the plurality of low beam reflector mounting clips 30, 32 is integrally formed as part of the housing 12.

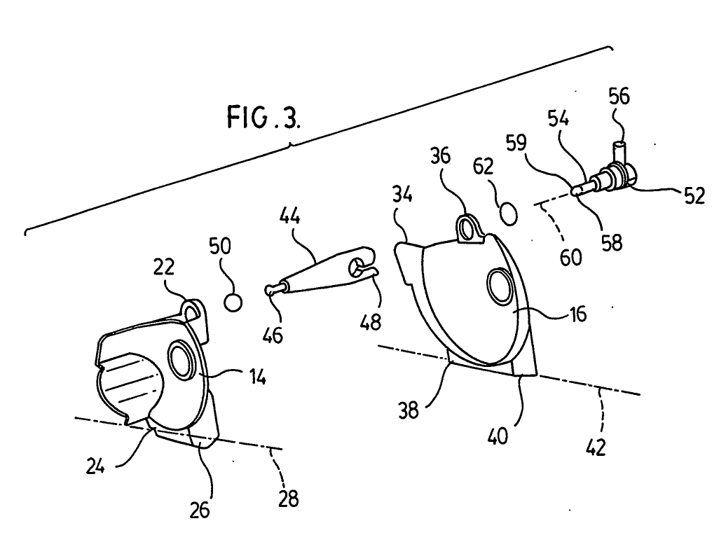

Referring to FIG. 3, the high beam reflector 14 is generally concave and is coated with a reflective coating. The base of the reflector 14 has a plurality of hinge posts 24, 26, which together define a high beam reflector rotation axis 28. Each of the plurality of hinge posts 24, 26 is pivotally secured to the housing 12 at one of the plurality of high beam reflector mounting clips 18, 20. The high beam reflector 14 also includes a connecting bar mount 22 at an end opposite the hinge post 24, 26. A ball socket 50 is fixedly secured to the connecting bar mount 22.

The low beam reflector 16 is generally concave and is coated with a reflective coating. The base of the low beam reflector 16 has a plurality of hinge posts 38, 40, which together define a low beam reflector rotation axis 42. Preferably, the axis 42 is staggered rearwardly of the low beam rotation axis 28, enabling the low beam reflector to be positioned outboard and rearwardly of the high beam reflector 14. Each of the plurality of hinge posts 38, 40 is pivotally secured to one of the plurality low beam reflector mounting clips 30, 32 to pivot the low beam reflector 16 about the low beam reflector rotation axis 42. The low beam reflector 16 also includes a hinge pin 34 and an adjustment mechanism mount 36 opposite the hinge posts 38, 40. A ball socket 62 is fixedly secured to the adjustment mechanism mount 36.

Although mounting clips and hinge posts are shown for pivotally mounting the high 14 and low 16 beam reflectors relative to the housing 12, it will be appreciated that numerous alternative pivotal attachment systems could be used to pivot the high 14 and low 16 beam reflectors.

A connecting bar 44 extends between the high 14 and low 16 beam reflectors. The connecting bar 44 includes a spherical ball at one end thereof 46 and a hinge clip 48 at an opposing end. The spherical ball 46 is connected to the ball socket 50 to pivotally secure the connecting bar 44 to the high beam reflector 14. Although a ball and socket connection is shown, it will be appreciated that any pivotal attachment system could be used to mount the connecting bar 44 to the high beam reflector 14.

The hinge clip 48 of the connecting bar 44 is connected to the hinge pin 34 of the low beam reflector 16 to pivotally secure the connecting bar 44 to the low beam reflector 16. Although a hinge clip and a hinge pin are shown, it will be appreciated that any pivotal attachment system could be used to mount the connecting bar 44 to the low beam reflector 16.

An adjustment mechanism 52, as commonly known to those skilled in the art, is fixedly secured to the housing 12, and includes a control rod 54 and a crank 56. The control rod 54 has a spherical ball 58 at a distal end 59, and defines a control rod axis 60. The ball 58 is secured to the ball socket 62 to pivotally mount the adjustment mechanism 52 to the low beam reflector 16.

In operation, movement of the high 14 and low 16 beam reflectors is accomplished by varying the position of the control rod 54 of the adjustment mechanism 52 longitudinally along the control rod axis 60. Turning the crank 56 clockwise causes the control rod 54 to extend outward from the adjustment mechanism 52 along the control rod axis 60. The movement of the control rod 54 along the control rod axis 60 causes the low beam reflector 16 to rotate counterclockwise about the low beam reflector rotation axis 42. The movement of the low beam reflector 16 compresses the connecting bar 44. In response, the high beam reflector 14 rotates in a counterclockwise direction about the high beam reflector rotation axis 28.

Conversely, turning the crank 56 of the adjustment mechanism 52 counterclockwise causes the control rod 54 to retract inward towards the adjustment mechanism 52 along the control rod axis 60. The inward movement of the control rod 54 along the control rod axis 60 causes the low beam reflector 16 to rotate clockwise about the low beam reflector rotation axis 42. The movement of the low beam reflector 16 tensions the connecting bar 44. In response, the high beam reflector 14 rotates in a counterclockwise direction about the high beam reflector rotation axis 28.

Thus, the single adjustment mechanism 52 allows for simultaneous pivotal adjustment of both the high 14 and low 16 beam reflectors. More importantly, the single adjustment mechanism enables the light assembly 10 to have a high aspect ratio to accommodate the sweep design trend in current vehicle styling.

Alternatively, the adjustment mechanism 52 could replace the connecting bar 44 and extend between the high 14 and low 16 beam reflectors. The adjustment mechanism 52 is provided with an extended control rod 54 that extends between the high 14 and low 16 beam reflectors. Activation of the adjustment mechanism 52 simultaneously pivots the high 14 and low 16 beam reflectors to aim the light beams projected by light bulbs 15, 17.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed:

1. A headlamp assembly for a motor vehicle, said headlamp assembly comprising:
a housing;
a first reflector pivotally secured to said housing and cooperating with a first light source to direct a first light beam;
a second reflector pivotally secured to said housing and cooperating with a second light source to a second light beam; and
a connecting bar pivotally connecting said first reflector to said second reflector.

2. A headlamp assembly as set forth in claim 1 including an adjustment mechanism extending between said housing and one of said first and second reflectors for simultaneously adjusting said reflectors and cooperatively aiming said first and second light beams.

3. A headlamp assembly as set forth in claim 2 wherein said connecting bar includes a spherical ball end pivotally secured to said first reflector and an opposing hinge clip end pivotally secured to said second reflector.

4. A headlamp assembly as set forth in claim 3 wherein said first reflector includes a connecting bar mount for receiving said spherical ball end of said connecting bar.

5. A headlamp assembly as set forth in claim 4 wherein said second reflector includes a hinge pin pivotally secured to said connecting bar at said hinge clip end thereof.

6. A headlamp assembly for a motor vehicle, said headlamp assembly comprising:
a housing;
a first reflector pivotally secured to said housing and cooperating with a first light source to direct a first light beam;
a second reflector pivotally secured to said housing and cooperating with a second light source to a second light beam; and
an adjustment mechanism pivotally connecting said first reflector to said second reflector and operative to simultaneously aim both reflectors.
